(19) United States
(12) Patent Application Publication
(10) Pub. No.: US 2008/0218547 A1
(43) Pub. Date: Sep. 11, 2008

(54) INK JET PRINTING APPARATUS AND INK JET PRINTING METHOD

(75) Inventors: Hideaki Takamiya, Yokohama-shi (JP); Koichiro Nakazawa, Machida-shi (JP); Takuei Ishikawa, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/041,385

(22) Filed: Mar. 3, 2008

(30) Foreign Application Priority Data
Mar. 6, 2007 (JP) 2007-056167

(51) Int. Cl. B41J 29/38

(52) U.S. Cl. 347/12

(57) ABSTRACT

An ink jet printing apparatus and method are provided which can satisfy in a well-balanced manner both an improvement of image uniformity and a reduction in glossiness variations. A plurality of print modes are prepared which include: a first print mode to perform a printing operation in a way that makes equal print ratios of the plurality of nozzle arrays; and a second print mode to perform a printing operation in a way that makes a print ratio of at least one of nozzle arrays situated at ends of the plurality of nozzle arrays smaller than print ratios of other nozzle arrays. The user selects from the plurality of print modes an appropriate one that strikes a balance between uniformity and glossiness and thereby can achieve a desired quality of image.

### BACKGROUND OF THE INVENTION

1. Field of the Invention

The present invention relates to an ink jet printing method and an ink jet printing apparatus to print an image on a print medium by using an ink jet print head with arrays of ink ejection nozzles.

2. Description of the Related Art

The present invention is applicable to any device that prints on print media of such materials as paper, cloth, leather, nonwoven fabric, OHP sheet and metal. More specifically, applicable devices include office equipment, such as printers, copying machines and facsimiles, and industrial production machines.

As information devices and communication devices, such as copying machines, word processors and computers, have come into wide use, ink jet printing apparatus that print digital images by an ink jet system have found a wide range of applications as one of image output devices for these information and communication devices. The ink jet printing apparatus use a print head having an array of a plurality of nozzles for printing. As demands for higher resolution and faster output speed are growing in recent years, integrated array technologies to meet these demands have seen significant advances. Many full multiple type ink jet printing apparatus using an elongate print head, in which a number of nozzles corresponding to a width of a print medium are densely arrayed, have been proposed.

In a full multiple type ink jet printing apparatus that uses an elongate print head, the elongate print head is fixed in the printing apparatus and ejects ink in the form of droplets from individual nozzles at a constant frequency. At the same time, a print medium is conveyed in a direction crossing the direction of a nozzle array at a constant speed corresponding to the ejection frequency and the print resolution. That is, with a single conveying operation of the print medium, a high resolution image can be output at high speed.

FIG. 10 shows nozzle arrays of an elongate print head 80 disclosed in Japanese Patent Laid-Open No. 2005-199696. In the figure, reference numbers 81, 82, 83 and 84 represent nozzle array groups each having two nozzle arrays. These nozzle array groups are arrayed in a zigzag shape.

The nozzle array groups 81-84 have the same configuration. A nozzle array group 81, for example, has a nozzle array 81A having nozzles arranged at a predetermined pitch in a Y direction (first direction) and a nozzle array 81B with the same nozzle pitch as the nozzle array 81A. These two nozzle arrays 81A, 81B are staggered in the Y direction by half a pitch. This arrangement allows for printing dots at a resolution two times the predetermined pitch on a print medium that is conveyed in an X direction (second direction). An elongate print head having these nozzle array groups arranged in zigzags is hereinafter referred to as a zigzag type print head.

Japanese Patent Laid-Open No. 2005-199692 discloses a method in which a plurality of nozzles for ejecting the same ink at the same pixel position in the sub-scan direction (Y direction in FIG. 10) are arranged in each nozzle array group and a line of one pixel width that is continuous in the main scan direction (X direction in FIG. 10) is printed by a plurality of nozzles.

FIG. 11 shows two nozzle array groups 20, 21 as an example of nozzle arrangement in the elongate print head disclosed in Japanese Patent Laid-Open No. 2005-199692. This publication discloses a print head which has the nozzle array groups of two nozzle arrays each (e.g., 24A and 24B), as shown in FIG. 11, arranged staggered from each other as shown in FIG. 12. The nozzle arrays 24A, 24B are arranged such that two nozzles, one each of the nozzle arrays 24A, 24B, are aligned at the same positions in the Y direction and controlled to alternate in printing a pixel line on a print medium that is conveyed in the X direction. As a result, each pixel line is printed with two kinds of dots ejected from two nozzles. This arrangement prevents characteristic variations of a particular nozzle in ejection volume and ejection direction from concentrating on one line, allowing a smoother image to be produced.

As shown in FIG. 11, overlapping areas are provided between boundary portions of the adjoining nozzle array groups. In a print head manufacturing process, it is unavoidable that some errors occur in the arrangement of individual nozzle array groups. So, black or white stripes may be recognized in image areas printed by the boundary portions of individual nozzle array groups. Even in such a case, if the overlapping areas are provided as shown in the figure, pixel lines extending in the X direction and printed by the overlapping areas of the nozzle array groups are each formed by four kinds of dots ejected from the two nozzle array groups. That is, should two nozzle array groups have any print position deviations, the deviations are prevented from concentrating on one location or line, rendering black or white stripes less noticeable at boundary areas in the printed image.

According to Japanese Patent Laid-Open No. 2005-199692, print data for one line is distributed among a plurality of nozzles by using a preset mask pattern. At this time, in areas where two nozzle array groups do not overlap, the print data is distributed between two nozzle arrays 24A, 24B or between 24C, 24D. In areas where the two nozzle array groups overlap, the print data is distributed among a total of four nozzle arrays 24A, 24B, 24C, 24D.

The above construction, in which lines of one pixel width running continuously in the print medium conveying direction (X direction) are each printed by a plurality of nozzles, can also be realized by other than the zigzag type print head.

FIG. 13A shows a construction of an elongate print head of other than the zigzag type and also a printing method using the elongate print head. Here, a print head 2 is shown to have four nozzle arrays 201A-201D parallelly arranged side by side in the X direction to eject the same ink. In this construction, four nozzles that eject the same ink are arranged at the same position in the Y direction, so these four nozzles can be alternated in printing a pixel line on a print medium that is conveyed in the X direction. Since each pixel line is formed by dots ejected from the four nozzles, a smoother image can be produced.

However, in the mode that is printed by using a plurality of nozzle arrays arranged side by side in the X direction as shown in FIGS. 10, 11 and 13A, compared to the mode that is printed by using one nozzle array, a phenomenon has been observed in which a glossiness of printed images is degraded. The inventors of this invention have found that the degradation of glossiness is caused by the fact that an increase in the number of nozzle arrays has resulted in an increase in the time it takes for the print head to print a unit area of a print medium.

FIG. 9 shows a result of examination conducted by the inventors, which represents a relation between a print density and image clarity of an output image when an image of a predetermined print density is printed on a unit area. The image clarity is a commonly used measure to evaluate glossiness, indicating how vivid a formed image is and how much deformation the image is free of. In this examination, two printing operations (ink application operations) are performed on a unit area to print images, each with a prescribed print density. A time interval between the two printing operations is changed and the figure shows test results for three different time intervals that are represented by different characteristic curves. The test results show that the image clarity is affected by the time interval between the two printing operations and that the greater the time interval, the larger the loss of image clarity.

As for a pigment ink in general, when the ink is applied to a print medium, water, one of contents of the pigment ink, is easily soaked into a print medium whereas pigment particles tend to remain on a surface of the print medium. If a new ink is subsequently applied overlappingly before the water of the preceding pigment ink is soaked, these inks mix together in a liquid state before fixing on the print medium. As a result, a relatively smooth pigment layer is formed over the surface of the print medium, producing an image with high glossiness.

If on the other hand a new ink is subsequently applied overlapping after the water of the preceding pigment ink has been soaked, a new pigment particle layer is formed over the pigment layer of the preceding pigment ink. As a result, a plurality of layers are formed, producing undulations on the surface of the print medium, degrading the glossiness of the print medium surface.

That is, when printing by using a plurality of nozzle arrays arranged in the X direction, as shown in FIGS. 10, 11 and 13A, the time required to print a unit area becomes greater than when one nozzle array is used for printing. As a result, the glossiness of the print medium surface is degraded.

It should, however, be noted that the glossiness degradation does not equally pose a problem for all kinds of print media. It is also noted that the level of requirements for glossiness varies depending on the use of printed materials and preferences of the user.

### SUMMARY OF THE INVENTION

The present invention has been accomplished in light of these problems and its objective is to provide an ink jet printing apparatus that can cope with a variety of requirements by providing a printing method capable of reducing a degradation of glossiness.

The first aspect of the present invention is an ink jet printing apparatus, comprising: a print head for printing an image on a print medium, the print head having a plurality of nozzle arrays corresponding to the same color ink, the plurality of nozzle arrays being arranged in a predetermined direction, each nozzle array having a plurality of nozzles arranged in a direction crossing the predetermined direction, setting unit that sets a first print mode capable of using all of the plurality of nozzle arrays to print the image on the print medium and a second print mode capable of using one or more nozzle arrays except for at least one of nozzle arrays situated at ends, in the predetermined direction, of the plurality of nozzle arrays to print the image on the print medium; and controller that causes the print head to print the image according to the print mode set by the setting unit.

The second aspect of the present invention is an ink jet printing apparatus, comprising: a print head for printing an image on a print medium, the print head having a plurality of nozzle array groups arranged in a first direction and corresponding to the same color ink, each nozzle array group having a plurality of nozzle arrays arranged in a second direction crossing the first direction, each nozzle array having a plurality of nozzles arranged in the first direction; setting unit that sets a first print mode capable of using all of the plurality of nozzle arrays for the nozzle array group and a second print mode capable of using one or more nozzle arrays except for at least one of nozzle arrays situated at ends in the predetermined direction for the nozzle array group; and controller that causes the print head to print the image according to the print mode set by the setting unit.

The third aspect of the present invention is an ink jet printing method of printing an image on a print medium by using a print head having a plurality of nozzle arrays corresponding to the same color ink, the plurality of nozzle arrays being arranged in a predetermined direction, each nozzle array having a plurality of nozzles arranged in a direction crossing the predetermined direction, comprising the steps of: setting of one of a plurality of print modes including a first print mode capable of using all of the plurality of nozzle arrays to print the image on the print medium and a second print mode capable of using one or more nozzle arrays except for at least one of nozzle arrays situated at ends, in the predetermined direction, of the plurality of nozzle arrays to print the image on the print medium; and printing the image according to the print mode set in the setting step.

The fourth aspect of the present invention is an ink jet printing apparatus that prints an image on a print medium by using a print head having a plurality of nozzle arrays arranged in a predetermined direction and corresponding to the same color ink, each nozzle array having a plurality of nozzles arranged in a direction crossing the predetermined direction, comprising: setting unit that sets a first print mode capable of using the plurality of nozzle arrays and a second print mode capable of using at least one of the plurality of nozzle array; and controller that causes the print head to print the image according to the print mode set by the setting unit, wherein in the second print mode, a print ratio of at least one of nozzle arrays situated at ends, in the predetermined direction, of the plurality of nozzle arrays is smaller than that in the first print mode.

The fifth aspect of the present invention is an ink jet printing apparatus that prints an image on a print medium by using a print head having a plurality of nozzle array groups arranged in a first direction and corresponding to the same color ink, each nozzle array group having a plurality of nozzle arrays arranged in a second direction crossing the first direction, each nozzle array having a plurality of nozzles arranged in the first direction, comprising: setting unit that sets a first print mode for performing a printing operation in a way that makes print ratios of the plurality of nozzle array substantially equal and a second print mode for performing a printing operation in a way that makes a print ratio of at least one of nozzle arrays situated at ends, in the second direction, of the plurality of nozzle arrays smaller than each of print ratios of other nozzle arrays; and controller that causes the print head to print the image according to the print mode set by the setting unit.

Further features of the present invention will become apparent from the following description of exemplary embodiments (with reference to the attached drawings).

### BRIEF DESCRIPTION OF THE DRAWINGS

FIG. 1 is a perspective view of an ink jet printing apparatus that can apply the present invention;

FIG. 2 is a plan view showing a positional relationship between a print head 2 mounted in an ink jet printing apparatus 1 and a print medium;

FIG. 3 is a schematic perspective view showing a part of an inner structure of one nozzle array in the print head;

FIG. 4 is a block diagram showing a rough configuration of a controller 9;

FIGS. 5A and 5B are diagrams to explain about a glossiness difference;

FIG. 6 is a plan view of two nozzle array groups showing a nozzle arrangement of an elongate print head used in an embodiment of this invention;

FIG. 7 is a plan view showing a nozzle arrangement of an elongate print head used in an embodiment of this invention;

FIGS. 8A-8C are plan views for showing characteristic uses of the nozzles in a print head in this invention;

FIG. 9 is a graph showing a relation between a print density and clarity of an image printed on a unit area at a predetermined print density;

FIG. 10 is a plan view showing a nozzle arrangement of an elongate print head disclosed in Japanese Patent Laid-Open No. 2005-199696;

FIG. 11 is a plan view of two nozzle array groups showing a nozzle arrangement of an elongate print head disclosed in Japanese Patent Laid-Open No. 2005-199692;

FIG. 12 is a plan view showing a nozzle arrangement of an elongate print head disclosed in Japanese Patent Laid-Open No. 2005-199692;

FIGS. 13A-13D are plan views showing nozzle arrangements of an elongate print head and characteristic uses of nozzles used in embodiment 1 of this invention; and

FIG. 14 is a plan view showing how nozzles are used in a mode that gives priority to glossiness of embodiment 4 of this invention.

### DESCRIPTION OF THE EMBODIMENTS

Now preferred embodiments of this invention will be described in detail by referring to the accompanying drawings.

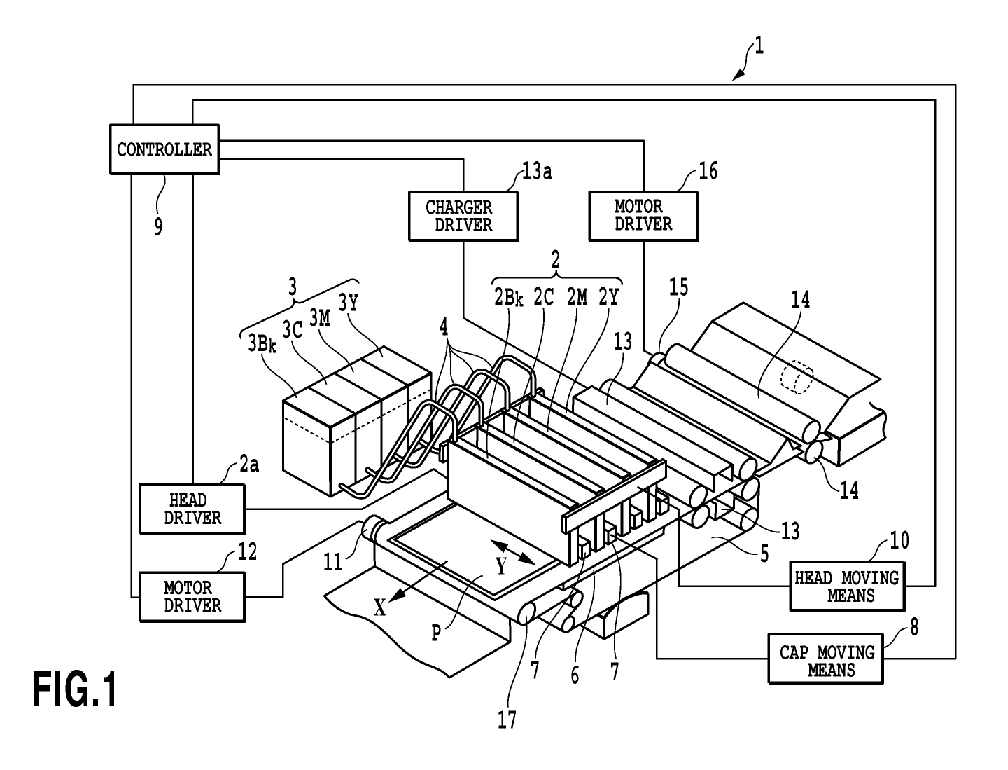

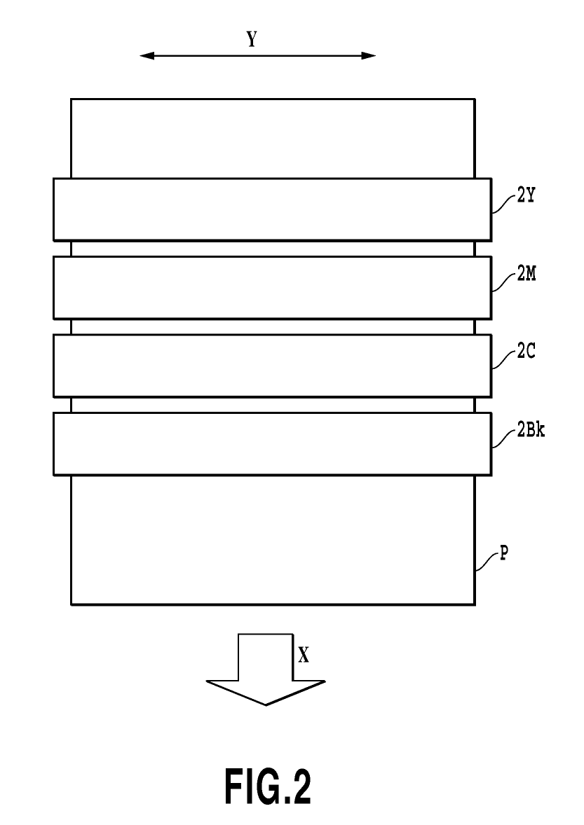

FIG. 1 is a perspective view of an ink jet printing apparatus that can apply the present invention. FIG. 2 is a plan view showing a positional relation between a print head 2 mounted in an ink jet printing apparatus 1 and a print medium.

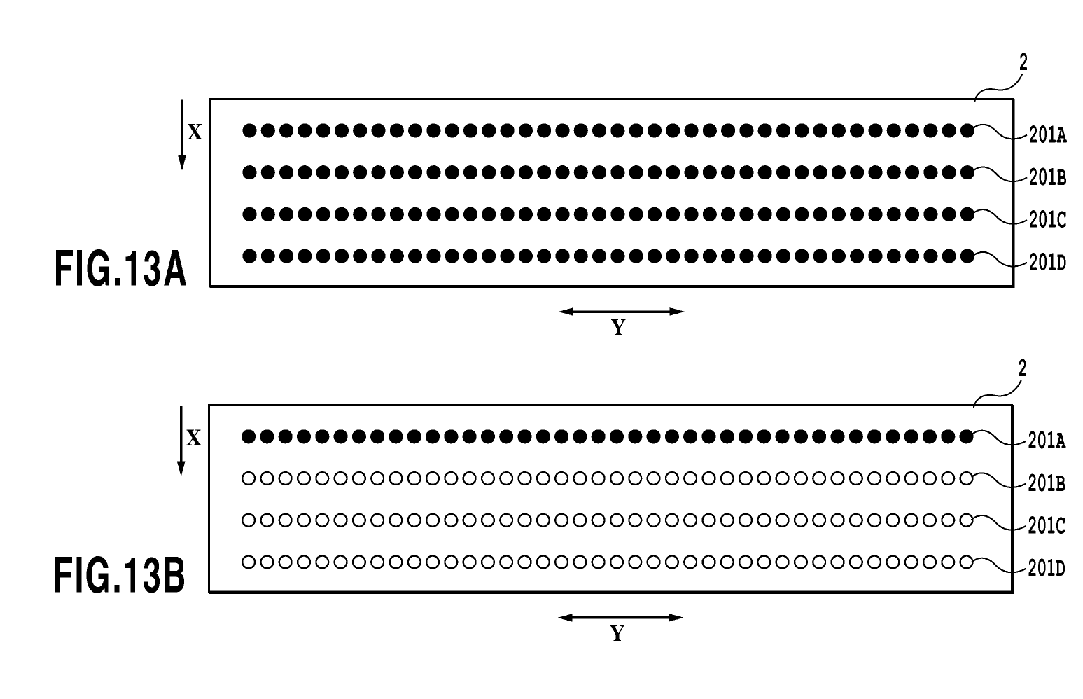

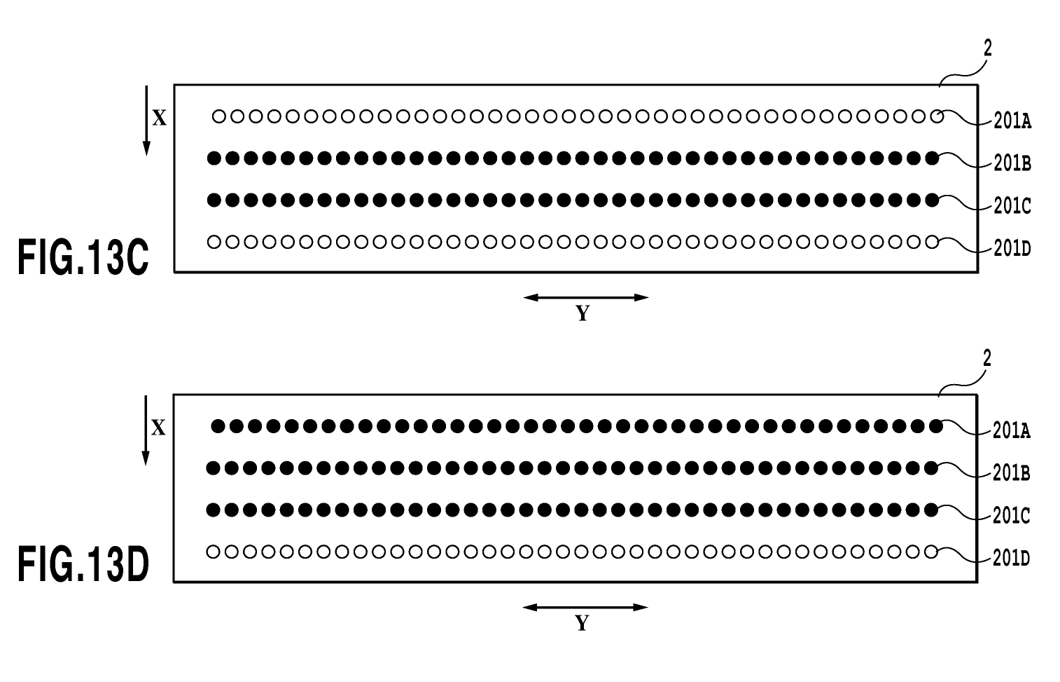

The ink jet printing apparatus 1 is a full line type printer having elongate print heads 2Y, 2M, 2C, 2Bk arranged side by side as shown in the figure, the print heads extending in a direction (Y direction or first direction) crossing a direction in which a print medium P is conveyed (X direction or second direction or a predetermined direction). Here, 2Y represents a print head that ejects a yellow ink, 2M a magenta ink ejecting print head, 2C a cyan ink ejecting print head, and 2Bk a black ink ejecting print head. These four color inks all contain pigments as colorants. These print heads are elongate print heads of almost the same construction. Details of arrangement of individual nozzle array groups are shown in FIG. 13A. In the descriptions that follow, all these print heads are generally referred to as a print head 2 unless it is necessary to distinguish them.

The print head 2 is connected through connecting pipes 4 to four ink tanks 3Y, 3M, 3C, 3Bk (hereinafter generally referred to as an ink tank 3) that contain a yellow ink, a magenta ink, a cyan ink and a black ink, respectively. Further, the ink tanks 3 are each removable from the connecting pipes 4 for their replacement.

A controller 9 controls devices shown in the figure to control an overall operation of the ink jet printing apparatus 1. In performing a printing operation, the controller 9 first drives a feed motor 15 by a motor driver 16 to rotate a pair of feed rollers 14. As the feed motor 15 rotates, a print medium P is fed in a direction X. Next, the controller 9 drives a motor driver 12 to rotate a belt drive motor 11. As the belt drive motor 11 rotates, a drive roller 17 connected to the belt drive motor 11 is rotated, causing a conveying belt 5 stretched around the roller to move. Further, the controller 9 activates a charger driver 13a to operate a charger 13 provided upstream of the conveying belt 5 to charge the print medium P conveyed there. The charged print medium P is attracted to the conveying belt 5 and carried by the conveying belt 5 in the X direction at a predetermined speed.

At a print position in a conveying path, there are provided a platen 6 that supports the print medium P from below and a print head 2 that prints on the print medium at this position. Nozzles of the print head 2 are electrically connected to the controller 9 through a head driver 2a and eject ink in response to a drive signal from the controller 9, forming dots on the print medium P that moves relative to the print head. As the controller 9 controls the speed at which to convey the print medium P and the frequency at which to eject ink from individual print heads 2 in an appropriate relationship, an image is formed on the print medium P at a predetermined resolution.

In executing a recovery operation on the print head 2, the controller 9 drives a head moving means 10 to move up the print head 2 away from the platen 6. Then, the controller 9 drives a cap moving means 8 to move a cap 7 directly below the print head 2. It further drives the head moving means 10 to lower the print head 2 toward the cap 7. The cap 7, while covering the ejection opening formed surface of the print head 2, receives waste ink discharged from the ejection openings or forcibly suck out ink from the ejection openings.

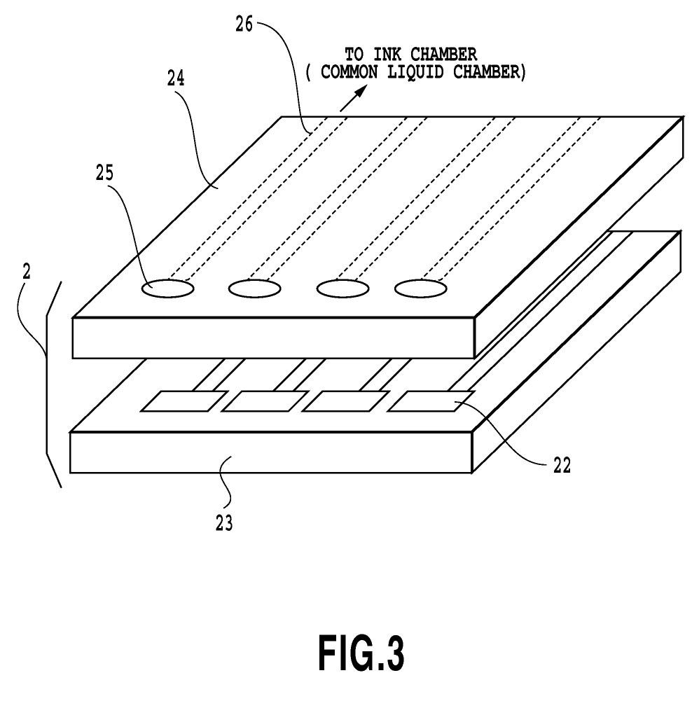

FIG. 3 is a schematic diagram showing a part of an internal structure of one nozzle array in the print head. “Nozzle” in this specification generally includes an ejection opening, a liquid path communicating with the ejection opening, and an element for generating energy to eject ink.

The print head 2 has a top plate 24 and a heater board 23. The top plate 24 is formed with a plurality of ejection openings 25 arranged at a predetermined pitch and a liquid path 26 to supply ink from an ink chamber to each of the ejection openings 25. The heater board 23 is formed with heaters 22 at positions corresponding to the individual ejection openings 25. When each of the heaters 22 is applied a predetermined drive voltage pulse, an air bubble is generated in ink directly above the heater 22. As the air bubble expands in volume, the ink is ejected from the ejection opening 25 in the form of droplet.

It is noted that a print head that can apply the present invention is not limited to ones using the heaters described above. For example, a pressure control system that ejects ink droplets from the ejection openings by mechanical vibrations, such as piezoelectric elements, may also be applied.

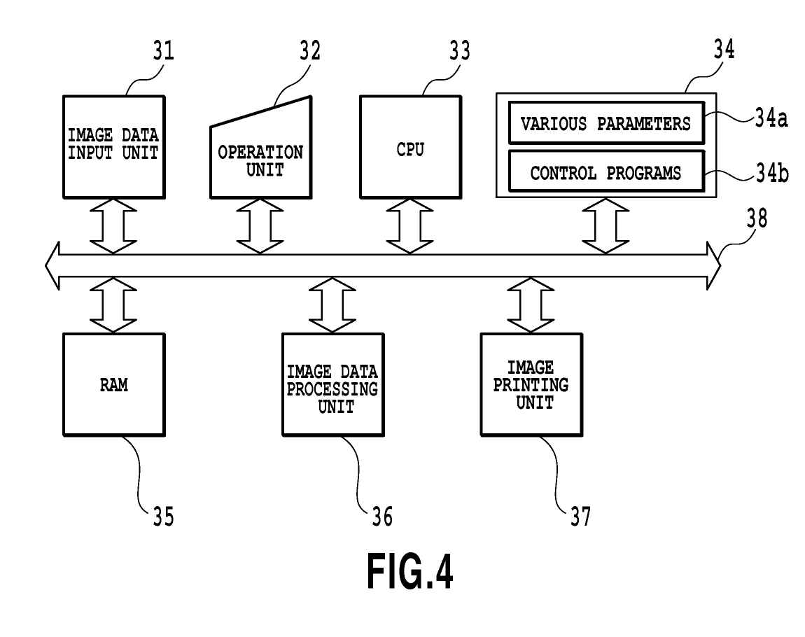

FIG. 4 is a block diagram roughly showing a configuration of the controller 9. Here, an image printing unit 37 represents all devices in FIG. 1 other than the controller 9.

In the figure, reference number 31 represents an image data input unit to take multi-valued image data into the printing apparatus. The image data input unit 31 inputs multi-valued image data from an image input device, such as scanner and digital camera, and also takes in multi-valued image data stored in hard disk drives of personal computers. Designated 32 is an operation unit for setting print conditions (e.c. print modes) and for instructing a print start. For example, the operation unit 32 sets one print mode selected by user from a plurality of print modes. Designated 33 is a CPU that controls the entire printing apparatus according to control programs 34b stored in storage media 34. In addition to the above control programs 34b, the storage media 34 stores various parameters 34a required for image processing and print operations. Tables for color conversion used for image processing executed by an image data processing unit described later and mask patterns to distribute print data among a plurality of nozzle arrays are also stored as parameters in the storage media 34. As the storage media 34, ROMs, FDs, CD-ROMs, HDs, memory cards and magneto-optical discs may be used. Designated 35 is a RAM that may be used by the CPU 33 as a work area when it executes the aforementioned various operations and also as a temporary save area in the event of errors.

Designated 36 is an image data processing unit to execute various image processing, such as color conversion and quantization operations, on multi-valued image data entered from the image data input unit 31. Methods that may be employed as the quantization operation include an error diffusion method, an average density conservation method and a dither matrix method. The multi-valued image data is quantized for conversion into binary data, according to which individual nozzles of the print head can perform the printing action. Then the binary data is distributed among a plurality of nozzle arrays according to a mask pattern that matches a print mode (first print mode or second print mode) described later. The binary data for each nozzle array is then sent to the image printing unit 37. As the mask pattern that distributes the print data (binary data) to a plurality of nozzle arrays, a multi-pass mask pattern assigned with a print ratio described later is used. Denoted 38 is a bus line to transmit address signals, data and control signals in the controller 9. Using the ink jet printing apparatus described with reference to FIGS. 1-4, the printing method characteristic of this invention will be explained in detail for a plurality of example embodiments.

### Embodiment 1

Now, a printing method using the print head of this embodiment will be explained. In this embodiment, one print mode selected by user from a plurality of print modes is set on the operation unit 32. The plurality of print modes include a print mode that gives priority to an image uniformity (first print mode) and a plurality of print modes that give priority to an image glossiness (a plurality of second print modes). In this embodiment, the first print mode is a print mode capable of using all of the plurality of nozzle arrays to print the image on the print medium. On the other hand, a second print mode is a print mode capable of using one or more nozzle arrays except for at least one of nozzle arrays situated at ends, in the predetermined direction, of the plurality of nozzle arrays to print the image on the print medium.

FIGS. 13A-13D show characteristic uses of nozzles in the print head 2 of this embodiment. FIG. 13A shows how nozzles are used when a first print mode that gives priority to image uniformity is selected. FIG. 13B shows how nozzles are used when a second print mode that gives priority to image glossiness is selected. In the figure, nozzles shown as a solid black circle are available for use in the selected mode and nozzles shown as a blank circle are not available for printing.

In this embodiment, the first print mode that gives priority to image uniformity uses all nozzle arrays 201A-201D. More specifically, binary data corresponding to a single pixel line extending in the X direction is distributed evenly among four nozzle arrays so that print ratios (usage ratios) of the four nozzle arrays are equal (25% each). The distribution of data is done by the mask pattern described above. Thus, a single pixel line made up of a plurality of pixels arranged in the X direction is printed by four nozzles, making it possible to produce a uniform image not affected by ejection variations among nozzles or by nozzle array group arrangement variations, as explained in the Background of the Invention. It is noted, however, that since the ink application operation is performed in four stages by the four nozzle arrays taking a relatively long duration of time corresponding to a conveying time over a distance L3, undulations may be formed on the image surface, making it impossible to achieve a high level of glossiness.

In the second print mode that gives priority to image glossiness, only one of the four nozzle arrays is used for printing. That is, a nozzle array 201A situated at one end is used for printing, whereas other nozzle arrays 201B-201D are not used. More specifically, binary data corresponding to a single pixel line extending in the X direction is distributed among the nozzle arrays so that a print ratio (usage ratio) of the nozzle array 201A is 100% while print ratios (usage ratios) of the other nozzle arrays 201B-201D are 0%. With this arrangement, the single pixel line made up of a plurality of pixels arranged in the X direction is printed by one nozzle, so that nozzle variations are more likely to appear in a printed image than in the first print mode that gives priority to the image uniformity. However, since the printing operation on a unit area is completed in one stage of ink application operation by one nozzle array, undulations are not easily formed over an image surface, thus producing a smooth and glossy image. Although in the above explanation only the nozzle array 201A has been described to be used for printing, any other nozzle 201A-201D may be used as long as only one of them is used, in realizing the similar effect of this embodiment. For example, each time a new page is created or each time a print job occurs, the nozzle array used may be changed.

In this way, in the second print mode of this embodiment, a print ratio of at least one of nozzle arrays situated at ends of the plurality of nozzle arrays is smaller than that of the first print mode. According to this constitution, the glossiness to be provided by the second print mode becomes greater than the glossiness to be provided by the first print mode.

That is, with this embodiment, based on whichever of image uniformity and image glossiness the user gives preference to, the user can choose one of the print modes and realize a desired image quality. It is noted that the selectable print modes in this embodiment are not limited to two but, as will be described later, it is possible to make three or more print modes selectable.

FIGS. 13C and 3D represent variations of the glossiness preference mode corresponding to the second print mode. The glossiness preference modes shown in FIGS. 13C and 13D are superior in glossiness to the uniformity preference mode (first print mode) but inferior to the glossiness preference mode of FIG. 13B. As for the uniformity, the glossiness preference modes shown in FIGS. 13C and 13D are inferior to the uniformity preference mode (first print mode) but superior to the glossiness preference mode of FIG. 13B.

More specifically, the glossiness preference mode shown in FIG. 13C uses two adjoining nozzle arrays out of the four nozzle arrays for printing. That is, the adjoining nozzle arrays 201B and 201C are used for printing but the nozzle arrays 201A and 201D situated at the ends are not used. Binary data corresponding to a single pixel line extending in the X direction is distributed to the nozzle arrays such that respective print ratios (usage ratios) of respective the nozzle arrays 201B, 201C are 50% and respective print ratios (usage ratios) of respective nozzle arrays 201A, 201D are 0%. With this arrangement, since the single pixel line made up of a plurality of pixels arrayed in the X direction is printed by two nozzles, nozzle variations are more likely to appear in a printed image than in the uniformity preference mode but a higher glossiness can be realized. When compared with the glossiness preference mode of FIG. 13B, this glossiness preference mode of FIG. 13C is inferior in glossiness but better in uniformity.

The glossiness preference mode shown in FIG. 13D uses three adjoining nozzle arrays out of the four nozzle arrays for printing. That is, nozzle arrays 201A-201C are used for printing but a nozzle array 201D is not used. More specifically, binary data for a single pixel line extending in the X direction is distributed among the nozzle arrays so that respective print ratios (usage ratios) of respective nozzle arrays 201A-201C are approximately 33% and a print ratio (usage ratio) of a nozzle array 201D is 0%. With this arrangement, a single pixel line made up of a plurality of pixels arranged in the X direction is printed by three nozzles. Therefore, as for the uniformity, the glossiness preference mode of FIG. 13D is superior to the glossiness preference mode of FIG. 13C but inferior to the uniformity preference mode. As for the glossiness, the glossiness preference mode of FIG. 13D is not as good as the glossiness preference modes of FIGS. 13B and 13C but superior to the uniformity preference mode.

The glossiness preference modes shown in FIGS. 13C and 13D are not limited to a particular nozzle array used for printing as with the glossiness preference mode of FIG. 13B. However, it is desired that the nozzle arrays used for printing adjoin in order to execute the ink application operation on a unit area of a print medium in as short a time as possible. Therefore, in the glossiness preference mode of FIG. 13C, it is also preferred that the nozzle arrays used for printing be a combination of nozzle arrays 201A and 201B or a combination of nozzle arrays 201C and 201D. In the glossiness preference mode of FIG. 13D, on the other hand, it is also preferred that the nozzle arrays used for printing be a combination of three nozzle arrays 201B, 201C and 201D.

The combination of print modes selectable in this embodiment is not limited to a combination of the four print modes shown in FIGS. 13A-13D described above. For example, the uniformity preference mode of FIG. 13A and the glossiness preference mode of FIG. 13C may be combined. Another combination may be a combination of the uniformity preference mode of FIG. 13A and the glossiness preference mode of FIG. 13B and FIG. 13D. Whatever combination is used, the only requirement is that the combination allows a selective execution of the uniformity preference mode (first print mode) and a glossiness preference mode (second print mode) capable of realizing a higher glossiness level than is possible with the uniformity preference mode. In this embodiment, the uniformity preference mode refers to a mode (first print mode) that prints in a way that makes the print ratios (usage ratios) of a plurality of nozzle arrays substantially equal. The glossiness preference mode on the other hand refers to a mode (second print mode) that prints in a way that makes the print ratio (usage ratio) of at least one of end nozzle arrays of a plurality of nozzle arrays smaller than each of the print ratios (usage ratios) of other nozzle arrays.

The first print mode of FIG. 13A has been explained to be a uniformity preference mode. In this embodiment, however, the first print mode does not need to be the uniformity preference mode. For example, the first print mode that can print a pixel line extending in the X direction with four nozzles can convey a print medium at a faster speed than other print modes, with the drive frequency of the print head kept as is. Taking advantage of this fact, the first print mode of this embodiment may be used as a speed preference mode. Anyway, the bias of the print rations (usage ratios) of the nozzle arrays used for the first print mode in this embodiment is smaller than those in the second print mode.

### Embodiment 2

This embodiment will explain a method of resolving a problem of degraded glossiness that occurs when a zigzag type elongate print head, such as disclosed in Japanese Patent Laid-Open No. 2005-199692, is used. In the following, a problem with the use of the zigzag type print head will be explained.

When a zigzag type print head is used, a difference occurs in glossiness between an image area printed with a central part of each nozzle array group and an image area printed with a boundary part of two nozzle array groups.

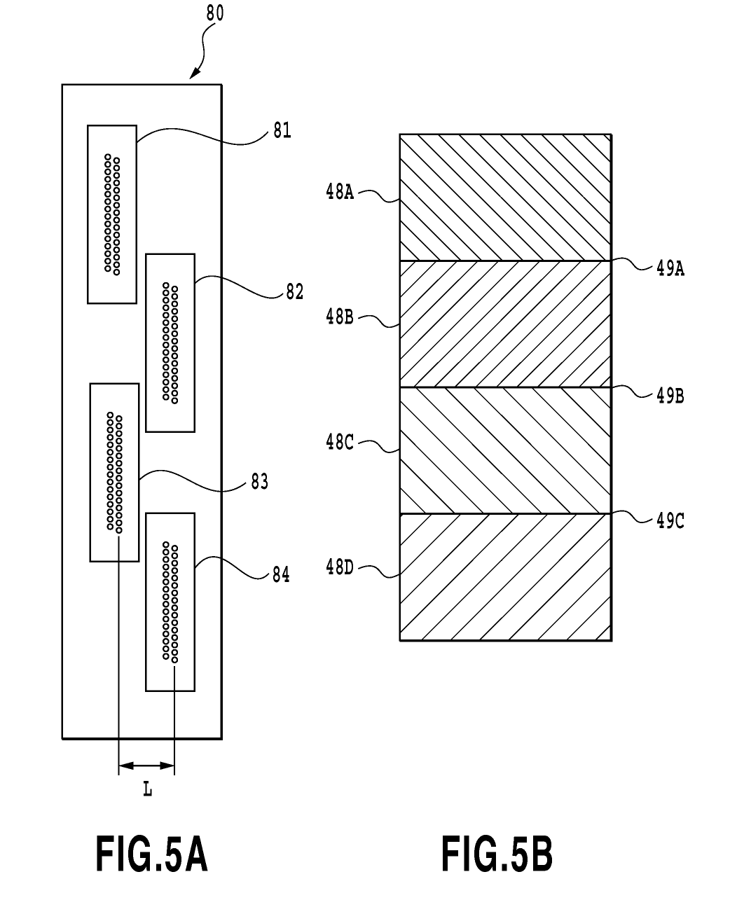

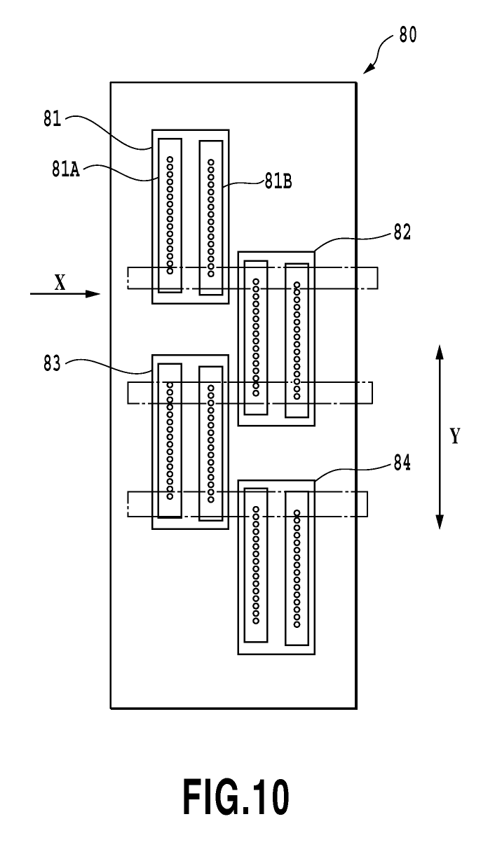

FIGS. 5A and 5B explain the difference in glossiness. FIG. 5A shows an elongate print head 80, the same as shown in FIG. 10. FIG. 5B shows a uniform gray image printed with the print head 80, with printed areas shown to match the associated nozzle array groups.

In the figure, an image area printed with a nozzle array group 81 is shown to be 48A, an image area printed with a nozzle array group 82 is shown to be 48B, an image area printed with a nozzle array group 83 is shown to be 48C, and an image area printed with a nozzle array group 84 is shown to be 48D. A boundary area formed by end portion nozzles of the nozzle array group 81 and nozzle array group 82 is designated 49A. A boundary area formed by end portion nozzles of the nozzle array group 82 and nozzle array group 83 is designated 49B. A boundary area formed by end portion nozzles of the nozzle array group 83 and nozzle array group 84 is designated 49C. An examination conducted by the inventors has found that the image areas 48A-48D have relatively high levels of glossiness while the boundary areas 49A-49C have relatively low levels of glossiness.

In the zigzag type elongate print head, ink is applied at one time when the image areas 48A-48D pass below the associated nozzle array groups 81-84. On the other hand, the boundary areas 49A-49C are applied with ink in two printing operations a time difference of which corresponds to a distance L between the two nozzle array groups. That is, this time difference causes undulations on the surface of the boundary areas 49A-49C, degrading the level of glossiness of the associated image areas compared with other image areas.

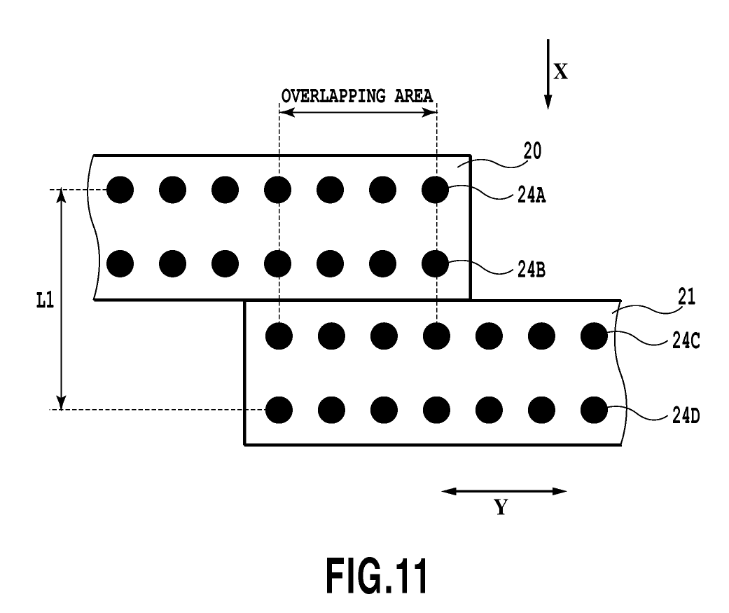

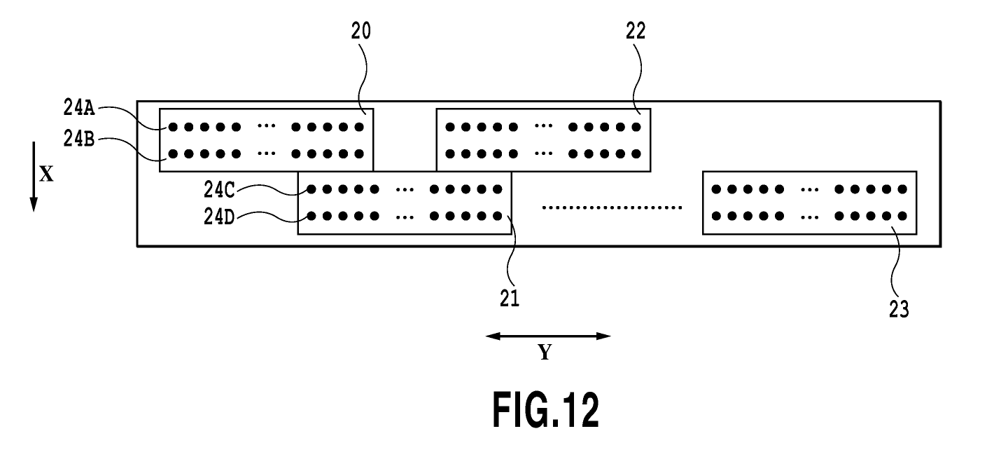

Returning again to FIG. 11 and FIG. 12, a zigzag type print head, such as disclosed in Japanese Patent Laid-Open No. 2005-199692, requires at least a certain magnitude of distance L between two nozzle array groups because of the construction of the print head. Thus, a glossiness difference is clearly recognized between a portion corresponding to other than the overlapping area where an image is completed by the nozzle arrays 24A and 24B and a portion corresponding to the overlapping area where an image is completed by all of the nozzle arrays 24A-24D. Further, because the overlapping area has certain measure of width (for four pixels in FIG. 11), the area with degraded glossiness becomes that much wider, rendering the glossiness variations more remarkable than it was when explained in FIG. 5.

Thus, in addition to limiting the number of nozzle arrays used for printing to give preference to the glossiness, as in embodiment 1, this embodiment also determines the nozzle arrays to be used for printing in a way that does not degrade the glossiness of the overlapping area in particular.

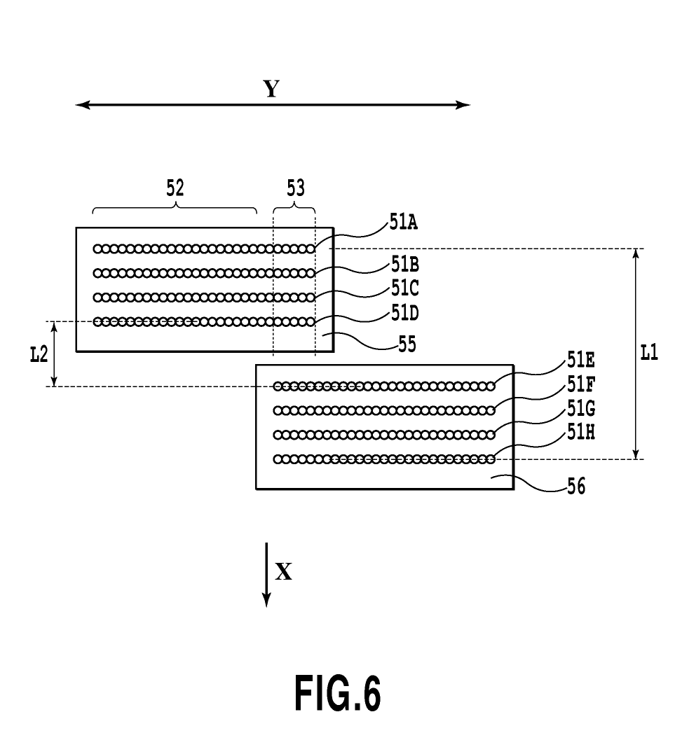

FIGS. 6 and 7 show a nozzle arrangement in a print head applied in embodiment 2. This embodiment has the number of nozzle arrays increased from that of the elongate print head disclosed in Japanese Patent Laid-Open No. 2005-199692 by four nozzle arrays. That is, a plurality of nozzle array groups each having four nozzle arrays arranged side by side in the X direction (second direction), or the print medium conveying direction, are arranged in the Y direction (first direction) while being alternately shifted in the X direction so that the ink jet print head has the nozzle array groups arranged in a zigzag. Then, print data (binary data) for a single line extending in the X direction is distributed among a plurality of nozzles by a preset mask pattern before being printed. At this time, in an area 52 where two nozzle array groups do not overlap, print data is distributed to the four nozzle arrays 51A, 51B, 51C and 51D. In an overlapping area 53, the print data is distributed among a total of eight nozzle arrays—nozzle arrays 51E, 51F, 51G, 51H in addition to the nozzle arrays 51A, 51B, 51C, 51D. The print head with the above nozzle array arrangement in this embodiment can realize an image with an excellent uniformity because it has more nozzle arrays than the print head disclosed in Japanese Patent Laid-Open No. 2005-199692. However, it is more likely to produce glossiness variations.

In the description that follows, a printing method using the print head of this embodiment will be explained. In this embodiment, too, the user selects one of a plurality of print modes on the operation unit 32 before starting the print operation. The print modes include a print mode that gives preference to an image glossiness and a print mode that gives preference to an image uniformity.

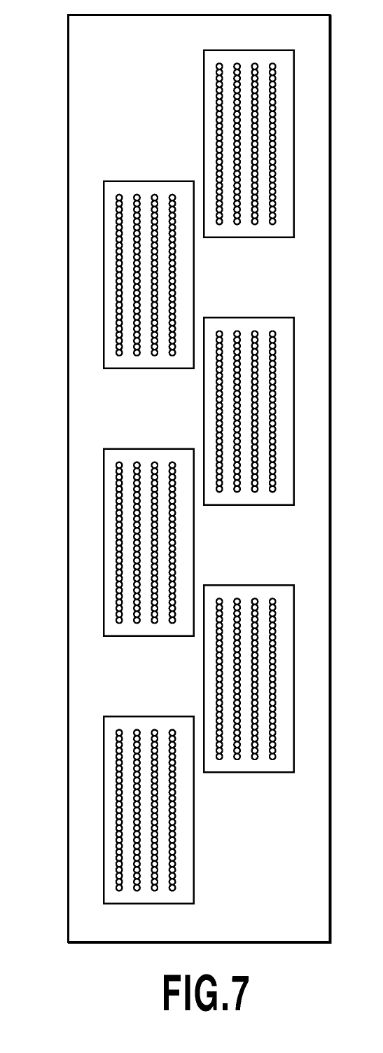

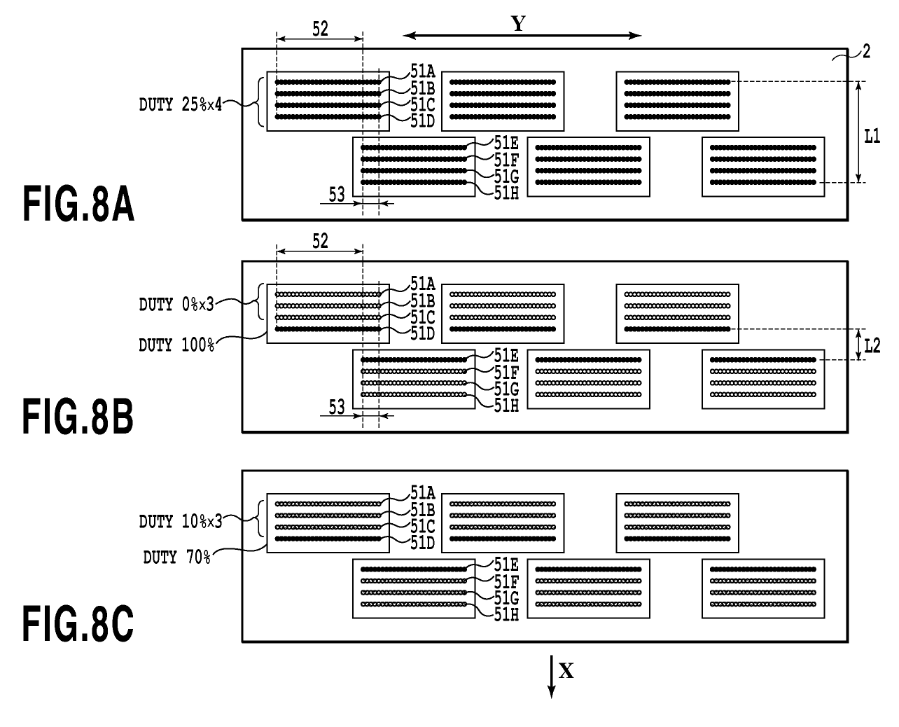

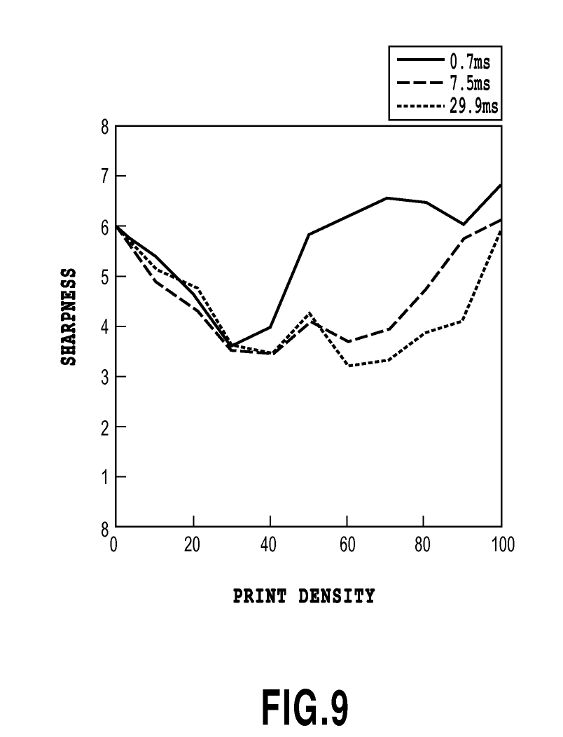

FIGS. 8A and 8B show characteristic uses of the nozzles in the print head 2 of this embodiment. FIG. 8A shows how nozzles are used when the first print mode that gives preference to an image uniformity is selected. FIG. 8B shows how nozzles are used when the second print mode that gives preference to an image glossiness is selected. In the figure, nozzles shown in black are available for use in the selected mode and those shown in white are not available for use in the selected mode.

In this embodiment, the first print mode that gives preference to uniformity uses all of the nozzle arrays in each nozzle array group for printing. Thus, a pixel line extending in the X direction is printed by four or eight nozzles, producing a uniform image not affected by nozzle ejection variations or nozzle array group arrangement variations. It is noted, however, that since in an image area printed by the overlapping area 53 of nozzle array groups, an image takes a relatively long duration of time to complete, corresponding to a conveying time over a distance L1, undulations may be formed on the image surface, making it impossible to realize a high level of glossiness.

The second print mode that gives preference to glossiness, on the other hand, uses only one nozzle array out of the four nozzle arrays in each nozzle array group that is closest to the adjoining nozzle array group in the X direction. That is, the nozzle arrays 51D and 51E closest to the adjoining nozzle array group are used for printing but the other nozzle arrays 51A-51C and 51F-51H are not used for printing. As described above, the nozzle arrays other than those (51D, 51E) closest to the adjoining nozzle array group in the X direction are set to a print ratio of 0%. Since a pixel line extending in the X direction is printed by one or two nozzles, this print mode is more likely to result in individual nozzle variations appearing in the printed image than in the print mode that gives preference to uniformity. However, in an area corresponding to a portion 52 other than the overlapping area, since the image printing is completed by a single ink application operation of one nozzle array, a smooth and glossy image can be expected to be formed. In an area corresponding to the overlapping area 53, the image printing is completed in a short duration of time corresponding to a relatively short distance L2, forming smaller undulations than in the uniformity preferential mode of FIG. 8A, which in turn renders the printed images smooth and glossy.

With this embodiment, by selecting one of print modes—a uniformity preference mode or a glossiness preference mode—whichever the user wishes, an image with a desired image quality can be produced.

In this embodiment, too, the first print mode does not have to be the uniformity preference mode as with embodiment 1. For example, the first print mode may be used as a speed preference mode. Anyway, the bias of the print rations of the nozzle arrays used for the first print mode in this embodiment is smaller than those in the second print mode.

### Embodiment 3

In this embodiment, too, the same print head as that of embodiment 2 is used and the user selects one of print modes on the operation unit 32 before starting the printing operation. In addition to the two print modes explained in the above embodiment 2, this embodiment provides a third print mode that offers an intermediate quality (uniformity and glossiness) between the two previous modes. This print mode realizes a higher glossiness level than that of the uniformity preference mode of FIG. 8A and therefore corresponds to a glossiness preference mode.

FIG. 8C shows how nozzles are used when a glossiness preference mode different from that of FIG. 8B is selected. In this print mode also, all of the nozzle arrays are used for printing, as in the first print mode that gives preference to uniformity. In this mode, however, the printing is done by providing a frequency-of-use (print ratio) deviation among the nozzle arrays. For example, in the first print mode explained in FIG. 8A, all the nozzle arrays are given a print ratio of 25% in the portion 52 and a print ratio of 12.5% in the overlapping area 53. In the print mode of FIG. 8C, on the other hand, nozzle arrays 51D and 51E are given a print ratio of 70% while other nozzle arrays 51A-51C and 51F-51H are also given a print ratio of 10% each in the area 52. Further, in the overlapping area 53, the nozzle arrays 51D and 51E are given a print ratio of 35% while the nozzle arrays 51A-51C and 51F-51H are given a print ratio of 5%. That is, in FIG. 8C, the nozzle arrays (51D, 51E) closest to the adjoining nozzle array group in the X direction are given the highest print ratio and the farthest nozzle arrays (51A, 51H) are given the lowest print ratio. With the print ratios of the nozzle arrays determined in this way, most of the printing operation is performed by the nozzle arrays 51D and 51E, thus assuring a higher glossiness than that of the print mode of FIG. 8A. Further, since some printing operations are also performed by other nozzle arrays than 51D and 51E, a printed image with a higher level of uniformity than that of the print mode of FIG. 8B can be produced.

It is of course possible to prepare a greater number of print modes by changing a distribution of print ratio among nozzle arrays or limiting the nozzle arrays to be used for printing. For example, the nozzle arrays 51D and 51E may be given a print ratio of 70%, while setting the nozzle arrays 51A and 51H to 5%, 51B and 51G to 10%, and 51C and 51D to 15% in the area 52. Further, the print ratio of the nozzle arrays 51A-51H does not need to be symmetrical with respect to a center of these arrays. For example, 51A and 51H may have different print ratios or only one of them is available for printing. The only requirement in determining the print ratios of the nozzle arrays is that the nozzle arrays 51D and 51E closest to the adjoining nozzle array group be given higher print ratios than those of other nozzle arrays situated farther away. With the print ratios determined in this manner, the glossiness variations can be reduced, which is an effect of this embodiment.

This embodiment can also be applied where a linear type print head is used as in embodiment 1. In that case, the nozzle array 201B and nozzle array 201C may be set to a print ratio of 40% while at the same time setting the nozzle array 201A and nozzle array 201D to a print ratio of 10%. With this setting arrangement, the effect similar to that of this embodiment can also be produced even with the print head of embodiment 1.

### Embodiment 4

Embodiment 2 and embodiment 3 have been described to improve the glossiness of an entire image by changing the nozzle arrays used for printing and the print ratios of individual nozzle arrays according to a print mode. In addition to the above, this embodiment is characterized in that, even in a glossiness preferential print mode, the number of nozzle arrays used for printing is differentiated between the overlapping area and other than the overlapping area, thus positively reducing glossiness variations in printed images.

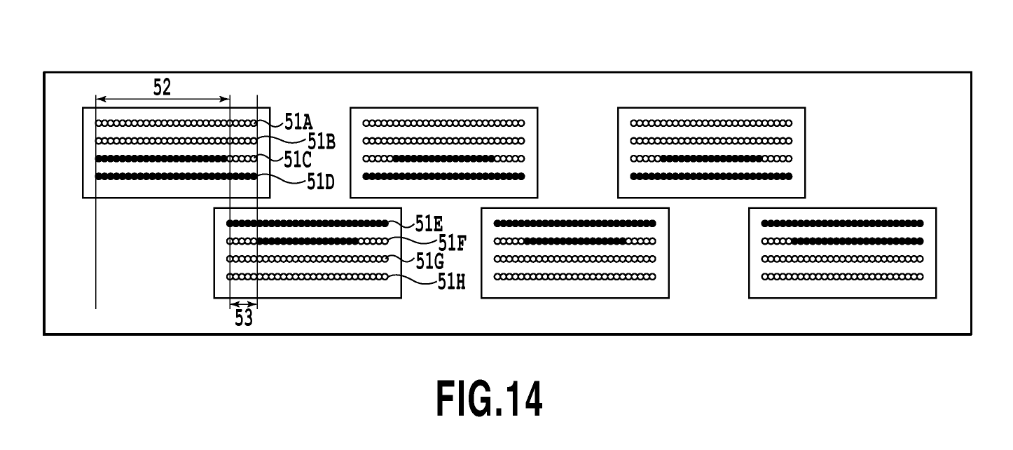

FIG. 14 is a schematic diagram showing how nozzles are used in a glossiness preferential mode of this embodiment. In the area 52 other than the overlapping area, two nozzle arrays 51C and 51D or two nozzle arrays 51E and 51F are used for printing. In the overlapping area 53, two nozzle arrays 51D and 51E are used. By using the nozzles as described above, the number of nozzle arrays used in the overlapping area 53 and in other than the overlapping area 52 can be made equal. This allows the ink application time required for printing the overlapping area 53 to approach the time required for other than the overlapping area 52. As a result, an undulation difference between the overlapping area 53 and other than the overlapping area 52 is minimized, reducing the glossiness variations in the entire image.

That is, this embodiment can produce a new effect of reducing a glossiness difference between the overlapping area and other than the overlapping area while at the same time enhancing the glossiness of the entire image in the glossiness preference print mode, the effect similar to that of the preceding embodiment.

The preceding construction have been described to make equal the numbers of nozzle arrays used for printing in the overlapping area 53 and other than the overlapping area 52. The present embodiment is not limited to this configuration. For example, if the glossiness level in the overlapping area is not enough even after the above method has been adopted, the overlapping area 53 may be printed by only one of the nozzle arrays 51D, 51E.

### Other Embodiments

According to embodiments 1 to 4, it is found that the first print mode usable in this invention is a print mode capable of using all of the plurality of nozzle arrays and the second print mode is a print mode capable of using at least one of nozzle arrays. Also, it is found that a print ratio of at least one of nozzle arrays situated at ends of the plurality of nozzle arrays, in the second print mode, is smaller than that in the first print mode.

In the above, example configurations of an elongate print head mounted in a full line type printing apparatus have been explained. The elongate print head may also be used in relatively large serial type printing apparatus. The serial type printing apparatus forms an image stepwise by repeating intermittently and alternately a main scan and a sub-scan, the main scan being adapted to eject ink as the print head scans (moves) over a print medium, the sub-scan being adapted to convey the print medium by an amount corresponding to a width of the print head. In such a printing apparatus, the above embodiments can be applied and the similar effects obtained. In that case, the direction in which the print head is scanned (moved) is an X direction (second direction or a predetermined direction) and the direction in which a print medium is conveyed (nozzle array direction) is a Y direction (first direction).

Although the printing method has been described to operate one print head using one ink color, it can of course be applied to a configuration where a plurality of print heads using a plurality of ink colors. In that case, if undulations vary depending on the kind of ink used, a distribution of the print ratio and the nozzle arrays used may be differentiated among the print heads in each print mode.

Further, although the above embodiments have been described to allow the user to select one of a plurality of print modes on the operation unit 32, the present invention is not limited to this configuration. For example, when a print medium is chosen which does not easily show glossiness variations or when a text image which is free of a uniformity problem is printed, an appropriate print mode may be automatically set without having to receive an instruction from the user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-056167, filed Mar. 6, 2007, which is hereby incorporated by reference herein in its entirety.

What is claimed is:

1. An ink jet printing apparatus, comprising:
a print head for printing an image on a print medium, the print head having a plurality of nozzle arrays corresponding to the same color ink, the plurality of nozzle arrays being arranged in a predetermined direction, each nozzle array having a plurality of nozzles arranged in a direction crossing the predetermined direction,
setting unit that sets a first print mode capable of using all of the plurality of nozzle arrays to print the image on the print medium and a second print mode capable of using one or more nozzle arrays except for at least one of nozzle arrays situated at ends, in the predetermined direction, of the plurality of nozzle arrays to print the image on the print medium; and
controller that causes the print head to print the image according to the print mode set by the setting unit.

2. An ink jet printing apparatus, comprising:
a print head for printing an image on a print medium, the print head having a plurality of nozzle array groups arranged in a first direction and corresponding to the same color ink, each nozzle array group having a plurality of nozzle arrays arranged in a second direction crossing the first direction, each nozzle array having a plurality of nozzles arranged in the first direction;
setting unit that sets a first print mode capable of using all of the plurality of nozzle arrays for the nozzle array group and a second print mode capable of using one or more nozzle arrays except for at least one of nozzle arrays situated at ends in the predetermined direction for the nozzle array group; and
controller that causes the print head to print the image according to the print mode set by the setting unit.

3. An ink jet printing method of printing an image on a print medium by using a print head having a plurality of nozzle arrays corresponding to the same color ink, the plurality of nozzle arrays being arranged in a predetermined direction, each nozzle array having a plurality of nozzles arranged in a direction crossing the predetermined direction, comprising the steps of:
setting of one of a plurality of print modes including a first print mode capable of using all of the plurality of nozzle arrays to print the image on the print medium and a second print mode capable of using one or more nozzle arrays except for at least one of nozzle arrays situated at ends, in the predetermined direction, of the plurality of nozzle arrays to print the image on the print medium; and
printing the image according to the print mode set in the setting step.

4. An ink jet printing apparatus that prints an image on a print medium by using a print head having a plurality of nozzle arrays arranged in a predetermined direction and corresponding to the same color ink, each nozzle array having a plurality of nozzles arranged in a direction crossing the predetermined direction, comprising:
setting unit that sets a first print mode capable of using the plurality of nozzle arrays and a second print mode capable of using at least one of the plurality of nozzle array; and
controller that causes the print head to print the image according to the print mode set by the setting unit,
wherein in the second print mode, a print ratio of at least one of nozzle arrays situated at ends, in the predetermined direction, of the plurality of nozzle arrays is smaller than that in the first print mode.

5. The ink jet printing apparatus according to claim 4,
wherein in the first print mode, print ratios of the plurality of nozzle arrays are substantially equal, and
in the second print mode, a print ratio of the at least one of nozzle arrays situated at ends is smaller than each of print ratios of other nozzle arrays.

6. The ink jet printing apparatus according to claim 5, wherein in the second print mode, the print ratio of the at least one of the nozzle arrays situated at ends is 0%.

7. The ink jet printing apparatus according to claim 5, wherein in the second print mode, print ratios of two of the nozzle arrays situated at ends are 0%.

8. The ink jet printing apparatus according to claim 5, wherein in the second print mode, a print ratio of one of the plurality of nozzle arrays is 100% and print ratios of other nozzle arrays are 0%.

9. The ink jet printing apparatus according to claim 5, wherein in the second print mode, print ratios of the plurality of nozzle arrays differ depending on their positions in the predetermined direction.

10. An ink jet printing apparatus that prints an image on a print medium by using a print head having a plurality of nozzle array groups arranged in a first direction and corresponding to the same color ink, each nozzle array group having a plurality of nozzle arrays arranged in a second direction crossing the first direction, each nozzle array having a plurality of nozzles arranged in the first direction, comprising:
setting unit that sets a first print mode for performing a printing operation in a way that makes print ratios of the plurality of nozzle array substantially equal and a second print mode for performing a printing operation in a way that makes a print ratio of at least one of nozzle arrays situated at ends, in the second direction, of the plurality of nozzle arrays smaller than each of print ratios of other nozzle arrays; and
controller that causes the print head to print the image according to the print mode set by the setting unit.

11. The ink jet printing apparatus according to claim 10,
wherein the plurality of nozzle array groups have at least a first nozzle array group and a second nozzle array group, and
wherein the first and second nozzle array groups are arranged at different positions in the first direction so that a print area of the first nozzle array group overlaps with a print area of the second nozzle array group.

12. The ink jet printing apparatus according to claim 11, wherein in the second print mode, print ratios of nozzle arrays other than a nozzle array that is closest to the second nozzle array group, among the plurality of nozzle array of the first nozzle array group, are 0%, and print ratios of nozzle arrays other than a nozzle array that is closest to the first nozzle array group, among the plurality of nozzle array of the second nozzle array group, are 0%.

13. The ink jet printing apparatus according to claim 11, wherein in the second print mode, a print ratio of a nozzle array that is closest to the second nozzle array group, among the plurality of nozzle array of the first nozzle array group, is higher than each of print ratios of other nozzle arrays of the first nozzle array group, and a print ratio of a nozzle array that is closest to the first nozzle array group, among the plurality of nozzle array of the second nozzle array group, is higher than each of print ratios of other nozzle arrays of the second nozzle array group.
